(19) United States
(12) Patent Application Publication
(10) Pub. No.: US 2019/0372324 A1
(43) Pub. Date: Dec. 5, 2019

(54) METHOD AND ASSEMBLY FOR SECURING COMPONENTS

(71) Applicants: BOMBARDIER INC., Dorval (CA); SHORT BROTHERS PLC, Belfast (IE)

(72) Inventor: Jean-Guy GAUDREAU, St-Bernardin (CA)

(21) Appl. No.: 16/336,529

(22) PCT Filed: Sep. 26, 2017
(86) PCT No.: PCT/IB2017/055870

§ 371 Date: Mar. 26, 2019

Related U.S. Application Data
(60) Provisional application No. 62/401,476, filed on Sep. 29, 2016.

(51) Int. Cl. H02G 3/32; B64D 37/04; B65D 63/10; F16L 3/233

(52) U.S. Cl. CPC H02G 3/32; B64D 37/04; B65D 2563/10; F16L 3/2336; B65D 63/1027

(57) ABSTRACT

An assembly for securing a first component to a second component, including an attachment bracket having two openings defined therethrough, each of the openings having a closed perimeter, and a tie element extending through the openings, the tie element including two abutment portions each sized relative to the openings to prevent the abutment portions from passing through the openings, the abutment portions being positioned on opposite sides of one of the openings with at least one of the abutment portions being positioned between the openings. The components may be a harness and a fuel probe, for example in a fuel tank of an aircraft.

### CROSS-REFERENCE TO RELATED APPLICATIONS

This application claims priority from U.S. provisional application No. 62/401,476 filed Sep. 29, 2016, the entire contents of which is incorporated by reference herein.

### TECHNICAL FIELD

The application relates generally to the securing of components and, more particularly, to the securing of components in an aircraft.

### BACKGROUND OF THE ART

Cable ties, also known as “tie-wraps”, are routinely used to attach components together. For example, cable ties engaged with a bracket of a first component can be used to secure a second component to the first component.

Some aircraft include a plurality of probes for measuring the fuel quantity in the fuel tank(s). Electrical harnesses can be attached to these probes by cable ties each separately engaged to the probe and harness. Because the fuel tanks provide a relatively harsh environment to the cable ties, some of the cable ties may break during use, which may cause the broken cable tie(s) to detach from the components and create foreign object debris (FOD) within the fuel tank. Such FOD can create damage, for example, by blocking the fuel filter(s).

### SUMMARY

In one aspect, there is provided an assembly for securing a first component to a second component, the assembly comprising: an attachment bracket having two openings defined therethrough, each of the openings having a closed perimeter; and a tie element extending through the openings, the tie element including two abutment portions each sized relative to the openings to prevent the abutment portions from passing through the openings, the abutment portions being positioned on opposite sides of one of the openings with at least one of the abutment portions being positioned between the openings.

In a particular embodiment, the assembly may have any of the following characteristics, or any combination of the following characteristics:
each of the abutment portions is positioned between the openings;
the tie element forms a loop having a closed perimeter;
the tie element includes two tie members interconnected at the abutment portions;
the tie element includes two interconnected cable ties, a gear rack of each of the cable ties being engaged with a pawl in a head of the other of the cable ties, the heads of the cable ties defining the abutment portions;
the attachment bracket includes a platform and two legs extending from the platform spaced apart from each other, each of the legs having one of the openings defined therethrough.

In another aspect, there is provided a probe and harness assembly, the assembly further comprising: two attachment brackets connected to the probe, each of the attachment brackets having two openings defined therethrough each having a closed perimeter; and for each of the attachment brackets, a respective tie element extending through the openings and surrounding the harness, the tie element including two abutment portions each sized relative to the openings to prevent the abutment portions from passing through the openings, the abutment portions being positioned on opposite sides of one of the openings with at least one of the abutment portions being positioned between the openings.

In a particular embodiment, the assembly may have any of the following characteristics, or any combination of the following characteristics:
the probe is a fuel probe, and the fuel probe and harness are located in a fuel tank of an aircraft;
each of the attachment brackets includes two legs spaced apart from each other each having one of the openings defined therethrough;
for each of the attachment brackets, each of the abutment portions of the respective tie element is positioned between the two openings;
each tie element forms a loop having a closed perimeter;
each tie element includes two tie members interconnected at the abutment portions;
each tie element includes two interconnected cable ties, a gear rack of each of the cable ties being engaged with a pawl in a head of the other of the cable ties, the heads of the cable ties defining the abutment portions.

In yet another aspect, there is provided a method for securing a first component to a second component, the method comprising: providing an attachment bracket having two openings defined therethrough, each of the openings having a closed perimeter; inserting a respective tie member through each of the openings; and interconnecting the tie members to surround the first component including positioning two abutment portions of the interconnected tie members on opposite sides of one of the openings with at least one of the abutment portions being positioned between the two openings, each of the abutment portions being larger than the openings and unable to pass therethrough, wherein the attachment bracket is connected to the second component.

In a particular embodiment, the method may include any of the following, or any combination of the following:
the attachment bracket is an integral part of the second component;
a step of connecting the attachment bracket to the second component through a connection different from the tie members;
the second component is a fuel probe and the first component is an electrical harness;
positioning the abutment portions is performed so that each of the abutment portions is positioned between the two openings;
each of the tie members includes one of the abutment portions, and interconnecting the tie members is performed by engaging each of the tie members with the abutment portion of the other of the tie members;
each of the tie members is a cable tie, each of the abutment portions being defined by a head of a respective one of the cable ties, and engaging each of the tie members with the abutment portion of the other of the tie members includes engaging a gear rack of each of the cable ties with a pawl in the head of the other of the cable ties.

In a further aspect, there is provided a method of attaching wiring to form a harness, the method comprising: surrounding the wiring with a first tie member forming a first loop; and surrounding the wiring with a second tie member forming a second loop while interlocking the first and second loops.

In a particular embodiment, the first and second tie members are cable ties.

### DESCRIPTION OF THE DRAWINGS

For a better understanding of the present invention, as well as other aspects and further features thereof, reference is made to the following description which is to be used in conjunction with the accompanying drawings, where:

FIG. 1 is a schematic tridimensional view of an exemplary aircraft;

FIG. 2 is a schematic tridimensional view of a probe secured to a wire harness, showing a tie element and attachment bracket assembly in accordance with a particular embodiment;

FIG. 3 is a schematic tridimensional view of part of the probe and wire harness of FIG. 2, showing the tie element and attachment bracket assembly from a different angle;

FIG. 4 is a schematic side view of the tie element and attachment bracket assembly and of part of the probe and wire harness of FIG. 2;

FIG. 5 is a schematic tridimensional view of a wire harness secured to a structural component, showing a tie element and attachment bracket assembly in accordance with another particular embodiment;

FIG. 6 is a schematic cross-sectional view of the harness and of the tie element and attachment bracket assembly taken along line 6-6 of FIG. 5; and

FIGS. 7-8 are opposite schematic tridimensional views of a wire harness with tie elements in accordance with another particular embodiment.

In the drawings, embodiments of the invention are illustrated by way of example. It is to be expressly understood that the description and drawings are only for purposes of illustration and as an aid to understanding. They are not intended to be a definition of the limits of the invention.

### DETAILED DESCRIPTION

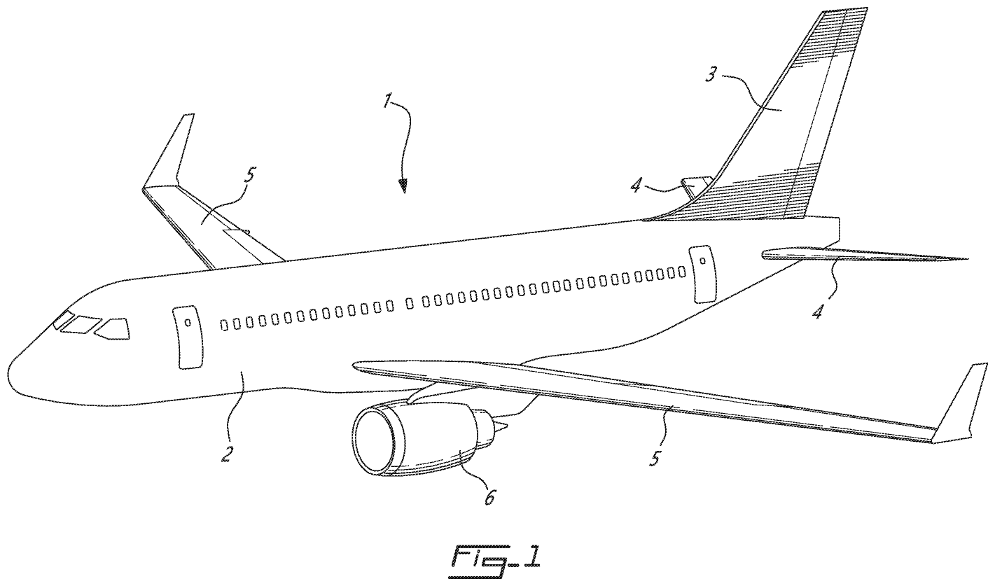

Referring to the drawings and more particularly to FIG. 1, an aircraft is shown at 1, and is generally described to illustrate some components for reference purposes in the present disclosure. The aircraft 1 has a fuselage 2 having a fore end at which a cockpit is located, and an aft end supporting a tail assembly, with the cabin generally located between the cockpit and the tail assembly. The tail assembly comprises a vertical stabilizer 3 with a rudder, and horizontal stabilizers 4 with elevators. The tail assembly has a fuselage-mounted tail, but other configurations may also be used for the aircraft 1, such as cruciform, T-tail, etc. Wings 5 project laterally from the fuselage. The aircraft 1 has engines 6 supported by the wings 5, although the engines 6 could also be mounted to the fuselage 2. The aircraft 1 is shown as a jet-engine aircraft, but may also be a propeller aircraft.

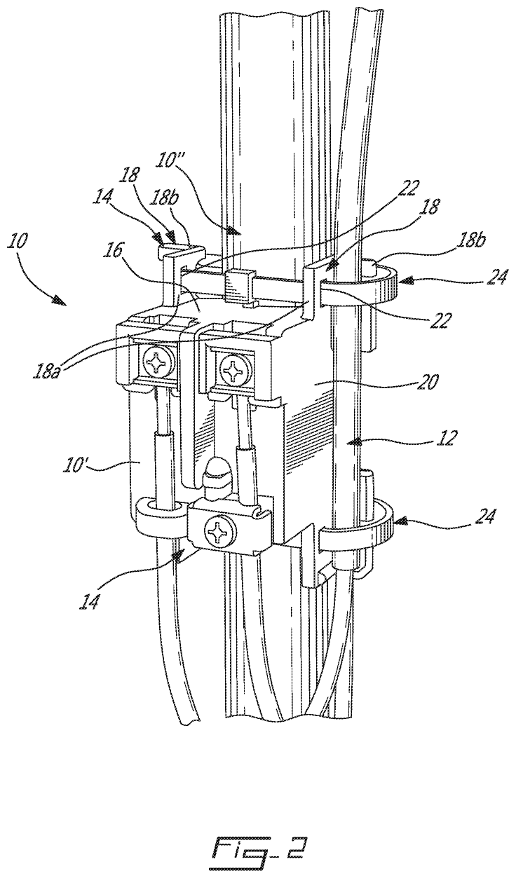

The aircraft includes one or more fuel tanks (not shown) which provide fuel to the engines 6. Referring to FIG. 2, each fuel tank includes a plurality of fuel probes 10 (only one of which is shown) suitably retained within the fuel tank. A harness 12 of electrical wires is connected to each probe 10. In a particular embodiment, each fuel probe 10 is a FQIS (fuel quantity indication system) probe within the fuel tank, configured to measure the quantity of fuel inside the tank; the data from the array of probes 10 is combined to compensate for variations in fuel position due to orientation, acceleration, etc. of the aircraft, so as to allow computation of the remaining fuel quantity.

In the embodiment shown, the probe 10 includes a housing 10′ connected to an elongated body 10″. Two attachment brackets 14 are connected to the housing 10′ of the probe 10, on opposed ends. In a particular embodiment, the attachment brackets 14 are integral parts of the probe housing 10′; alternately, the attachment bracket(s) 14 may be separately manufactured and connected to the probe 10 in any suitable manner, or can be defined as elements separate from the probe 10.

In the embodiment shown, each attachment bracket 14 includes a platform 16 defining an end wall of the housing 10′, and two legs 18 extending from the platform 16. Each leg 18 has an L-shape cross-section, formed by first and second interconnected plates 18a, 18b. The first plates 18a of the legs 18 extend parallel to each other, spaced apart along a direction perpendicular to the first plates 18a, as part of side walls 20 of the housing 10′. The second plates 18b are located in a common plane and extend outwardly from the side walls 20. It is understood that the particular configuration shown for the attachment bracket 14 is exemplary, and that other configurations are also possible.

The attachment bracket 14 includes two openings 22 defined therethrough, which in the embodiment shown are defined through the first plates 18a of the legs 18 in alignment with each other. The openings 22 have a closed perimeter, i.e. each opening 22 is completely surrounded by the material of the attachment bracket 14.

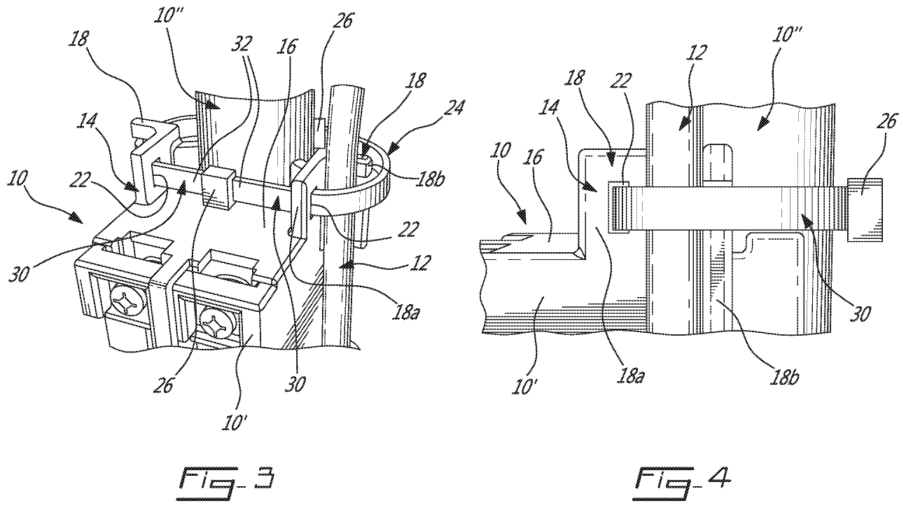

Referring to FIGS. 3-4, each attachment bracket 14 engages a respective tie element 24, which extends through the openings 22. Each tie element 24 includes two abutment portions 26 (FIG. 4) which are larger than the openings 22, i.e. the openings 22 are sized relative to the abutment portions 26 so that the abutment portions 26 cannot pass through the openings 22. Abutment of the abutment portion 26 against the surface of the attachment bracket 14 surrounding the opening 22 thus blocks a sliding motion of the tie element 24 toward that surface.

As can be best seen in FIG. 3, in the embodiment shown the tie element 24 forms a loop having a closed perimeter, and the abutment portions 26 are positioned between the openings 22 on opposite sides of one of the openings 22. In other words, a pattern of alternating opening 22 and abutment portion 26 is formed along the perimeter of the tie element 24.

The tie element 24 surrounds the harness 12 and the body portion 10″ of the probe 10, thus securing the harness 12 to the attachment bracket 14, and accordingly to the probe 10. In the embodiment shown, the body portion 10″ is received between the legs 18 of the attachment bracket 14 in the loop of the tie element 24, and the harness 12 is positioned in the corner formed by the intersection of the plates 18a, 18b defining one of the legs 18, also in the loop of the tie element 24. The configuration of the attachment bracket 14 and its position with respect to the body portion 10″ and housing 10′ of the probe 10 thus allows for the harness 12 to be retained on one side or the other of the probe 10, as required.

In an alternate embodiment where the attachment bracket 14 is separate from the probe 10, the tie element 24 can be used to secure the attachment bracket 14 to both the probe 10′ and the harness 12.

In the embodiment shown and as can be best seen in FIG. 3, the tie element 24 is formed by two tie members 30 which are interconnected at the abutment portions 26. As shown, each tie member 30 is a cable tie, with a strap portion 32 defining a gear rack and a head defining the abutment portion 26 and having an opening for receiving the strap portion 32. Accordingly, the gear rack of the strap portion 32 of each cable tie 30 is received in the opening of the head/abutment portion 26 of the other cable tie 30, where it engages a pawl to form a ratchet connection. The openings 22 of the attachment bracket 14 are thus sized so as to be able to receive the strap portions 32 while preventing the heads/abutment portions 26 from passing therethrough.

In a particular embodiment, the abutment portions 26 located between the openings 22 allow for the abutment portions 26 to block the tie element 24 from sliding out of engagement with the attachment bracket 14 upon rupture of the tie element 24. More specifically, by having two abutment portions 26 each located between the openings 22 in the legs 18 on either side of one of the legs 18, no matter where a break in the tie element 24 occurs, it is retained by the attachment bracket 14 by one of the abutment portions 26. Retention of the broken tie element 24 to the attachment bracket 14 prevents the broken tie element 24 from creating foreign object debris (FOD) within its environment, for example the fuel tank. Once the tie element 24 is broken, tension in the tie element 24 is released, which renders a second rupture (which might lead to FOD) improbable.

In an alternate embodiment, three or more openings 22 may be provided in the attachment bracket 14, with a corresponding number of abutment portions 26 being provided on the tie element 24. Each of the abutment portions 26 is located between a respective pair of the openings 22 to retain the tie element 24 in engagement with the attachment bracket 14 upon rupture of the tie element 24.

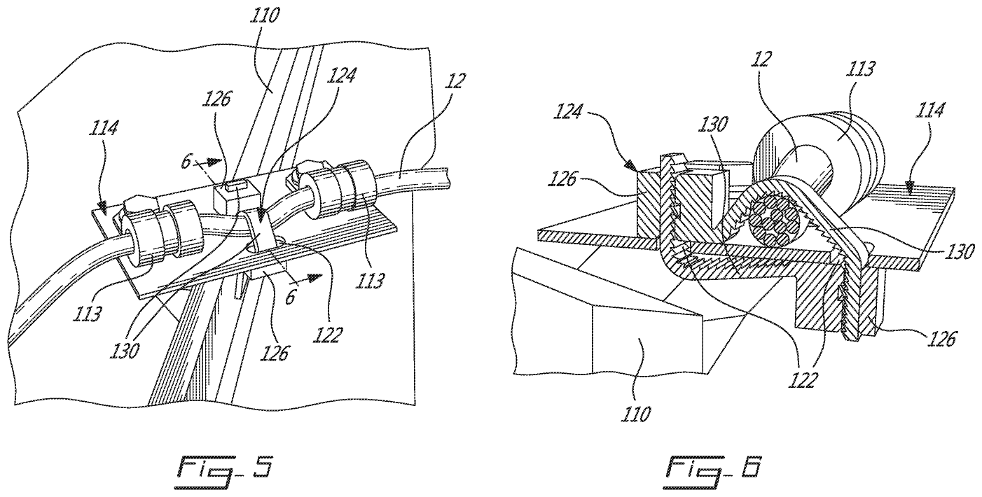

Referring to FIGS. 5-6, an attachment bracket 114 and tie element 124 assembly according to another embodiment is schematically shown, used to retain the electrical harness 12 to a structural component 110 of the aircraft, such as, for example, a rib, a stiffener, a frame member, a stringer, etc. In the particular embodiment shown, the attachment bracket 114 is engaged to the component 110 by a pair of clamps 113; alternately, the attachment bracket 114 may be engaged to the component 110 by the tie element 124 and/or by additional similar tie elements.

The attachment bracket 114 is in the form of a plate, through which two openings 122 (FIG. 6) having a closed perimeter are defined. The tie element 124 extends through the openings 122. As in the embodiment of FIGS. 2-4, the tie element 124 includes two abutment portions 126 which are larger than the openings 122 so that the abutment portions 126 cannot pass through the openings 122. The tie element 124 forms a loop having a closed perimeter, and the abutment portions 126 are positioned between the openings 122 on opposite sides of one of the openings 122. The tie element 124 surrounds the harness 12, thus securing the harness 12 to the attachment bracket 114, and accordingly to the component 110.

Similarly to the embodiment of FIGS. 2-4, the tie element 124 is formed by two tie members 130 which are interconnected at the abutment portions 126. For example and as shown, each tie member 130 is a cable tie, with the head of the cable ties defining the abutment portion 126.

In use and in accordance with a particular embodiment, two components such as the electrical harness 12 and the fuel probe 10, or the electrical harness 12 and the structural component 110, are secured to each other by providing the attachment bracket 14, 114 connected to one of the components (e.g. probe 10, component 110), for example as an integral part of the component or attached thereto using any suitable type of connection. A respective tie member 30, 130 (e.g. cable tie) is inserted through each of the openings 22, 122 of the attachment bracket 14, 114. The tie members 30, 130 are interconnected to surround the other component (e.g. harness 12); this is performed while positioning the abutment portions 26, 126 on opposite sides of one of the openings 22, 122 with at least one of the abutment portions 26, 126 being positioned between the two openings 22, 122, so as to prevent the tie members 30, 130 from being released if a break occurs after assembly.

In the embodiment shown, the tie members 30, 130 are interconnected by engaging each of the tie members 30, 130 with the abutment portion or head 26, 126 of the other of the tie members 30, 130; the gear rack of each cable tie is engaged in the head of the other one of the cable ties to form the connection.

In a particular embodiment, the attachment bracket 14, 114 and tie element 24, 124 assembly provides for a simple and inexpensive way to attach an electrical harness to a fuel probe 10 in a fuel tank, or to any component 110 of the aircraft, while reducing or eliminating the risk of FOD from the tie elements 24, 124 upon failure.

Although the assembly has been shown and described in relation to the securing of an electrical harness 12 to a fuel probe 10 or to an aircraft component 110, it is understood that a similar attachment bracket 14, 114 and tie element 24, 124 assembly could be used to secure other types of components, in fuel tanks and elsewhere.

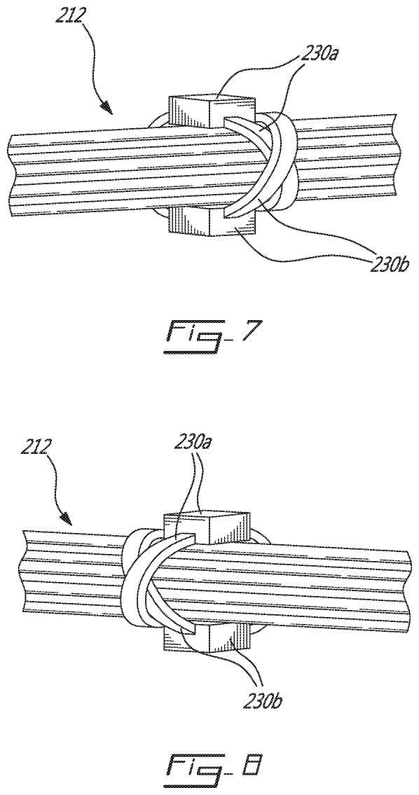

Referring to FIGS. 7-8, a method of attaching wiring to form a harness 212 in accordance with a particular embodiment is shown. The wiring is surrounded by a first tie member 230a (e.g. cable tie) with the tie member 230a forming a loop around the wiring. The wiring is also surrounded by a second tie member 230b (e.g. cable tie) with the tie member 230b forming a loop around the wiring, while interlocking the two loops 230a, 230b. Each of the tie members 230a, 230b acts as a safety retention mechanism, retaining the other tie member 230a, 230b in place if it breaks to prevent its release from the harness 212.

While the methods and systems described herein have been described and shown with reference to particular steps performed in a particular order, it will be understood that these steps may be combined, sub-divided or reordered to form an equivalent method without departing from the teachings of the present invention. Accordingly, the order and grouping of the steps is not a limitation of the present invention.

Modifications and improvements to the above-described embodiments of the present invention may become apparent to those skilled in the art. Accordingly, the foregoing description is intended to be exemplary rather than limiting. The scope of the present invention is therefore intended to be limited solely by the scope of the appended claims.

1. An assembly for securing a first component to a second component, the assembly comprising:
an attachment bracket having two openings defined therethrough, each of the openings having a closed perimeter; and
a tie element extending through the openings, the tie element including two abutment portions each sized relative to the openings to prevent the abutment portions from passing through the openings, the abutment portions being positioned on opposite sides of one of the openings with at least one of the abutment portions being positioned between the openings.

2. The assembly as defined in claim 1, wherein each of the abutment portions is positioned between the openings.

3. The assembly as defined in claim 1, wherein the tie element forms a loop having a closed perimeter.

4. The assembly as defined in claim 1, wherein the tie element includes two tie members interconnected at the abutment portions.

5. The assembly as defined in claim 1, wherein the tie element includes two interconnected cable ties, a gear rack of each of the cable ties being engaged with a pawl in a head of the other of the cable ties, the heads of the cable ties defining the abutment portions.

6. The assembly as defined in claim 1, wherein the attachment bracket includes a platform and two legs extending from the platform spaced apart from each other, each of the legs having one of the openings defined therethrough.

7. A probe and harness assembly, the assembly further comprising:
two attachment brackets connected to the probe, each of the attachment brackets having two openings defined therethrough each having a closed perimeter; and
for each of the attachment brackets, a respective tie element extending through the openings and surrounding the harness, the tie element including two abutment portions each sized relative to the openings to prevent the abutment portions from passing through the openings, the abutment portions being positioned on opposite sides of one of the openings with at least one of the abutment portions being positioned between the openings.

8. The assembly as defined in claim 7, wherein the probe is a fuel probe, and wherein the fuel probe and harness are located in a fuel tank of an aircraft.

9. The assembly as defined in claim 7, wherein each of the attachment brackets includes two legs spaced apart from each other each having one of the openings defined therethrough.

10. The assembly as defined in claim 7, wherein for each of the attachment brackets, each of the abutment portions of the respective tie element is positioned between the two openings.

11. The assembly as defined in claim 7, wherein each tie element forms a loop having a closed perimeter.

12. The assembly as defined in claim 7, wherein each tie element includes two tie members interconnected at the abutment portions.

13. The assembly as defined in claim 7, wherein each tie element includes two interconnected cable ties, a gear rack of each of the cable ties being engaged with a pawl in a head of the other of the cable ties, the heads of the cable ties defining the abutment portions.

14. A method for securing a first component to a second component, the method comprising:
providing an attachment bracket having two openings defined therethrough, each of the openings having a closed perimeter;
inserting a respective tie member through each of the openings; and
interconnecting the tie members to surround the first component including positioning two abutment portions of the interconnected tie members on opposite sides of one of the openings with at least one of the abutment portions being positioned between the two openings, each of the abutment portions being larger than the openings and unable to pass therethrough, wherein the attachment bracket is connected to the second component.

15. The method as defined in claim 14, wherein the attachment bracket is an integral part of the second component.

16. The method as defined in claim 14, further comprising connecting the attachment bracket to the second component through a connection different from the tie members.

17. The method as defined in claim 14, wherein the second component is a fuel probe and the first component is an electrical harness.

18. The method as defined in claim 14, wherein positioning the abutment portions is performed so that each of the abutment portions is positioned between the two openings.

19. The method as defined in claim 14, wherein each of the tie members includes one of the abutment portions, and interconnecting the tie members is performed by engaging each of the tie members with the abutment portion of the other of the tie members.

20. The method as defined in claim 17, wherein each of the tie members is a cable tie, each of the abutment portions being defined by a head of a respective one of the cable ties, and engaging each of the tie members with the abutment portion of the other of the tie members includes engaging a gear rack of each of the cable ties with a pawl in the head of the other of the cable ties.

21. A method of attaching wiring to form a harness, the method comprising:
surrounding the wiring with a first tie member forming a first loop; and
surrounding the wiring with a second tie member forming a second loop while interlocking the first and second loops.

22. The method as defined in claim 21, wherein the first and second tie members are cable ties
